(19) United States
(12) Patent Application Publication
(10) Pub. No.: US 2009/0166451 A1
(43) Pub. Date: Jul. 2, 2009

(54) Wind-Powered Irrigation Machine

(75) Inventors: Richard W. Parod, Elkorn, NE (US); Charles H. Meis, Albion, NE (US)

Correspondence Address: HOVEY WILLIAMS LLP, 10801 Mastin Blvd., Suite 1000, Overland Park, KS, 66210, US

(73) Assignee: LINDSAY CORPORATION, Omaha, NE (US)

(21) Appl. No.: 11/964,972

(22) Filed: Dec. 27, 2007

(51) Int. Cl. B05B 3/00

(52) U.S. Cl. 239/723

(57) ABSTRACT

An apparatus and method of moving a mobile tower using wind energy are disclosed for use with an irrigation system. The disclosed improvement includes a rotor assembly operable to be rotated by the movement of passing air, a generator of electrical energy driven by the rotation of the rotor assembly, an electrical charge source in communication with the generator, and a motor to drive a ground-engaging wheel in communication with the electrical charge source. The method of moving the mobile tower includes rotating wind-receiving elements of a rotor assembly with wind energy in passing air, generating electrical energy from the wind energy, and driving a wheel of the mobile tower with a motor powered by the generated electrical energy.

### TECHNICAL FIELD

The present invention relates generally to agricultural irrigation systems. More particularly, the present invention concerns a wind powered irrigation machine that uses wind energy to rotate a rotor assembly, generates electrical energy from the rotation of the rotor assembly, and uses the generated electrical energy to power a drive motor on a mobile tower of the irrigation machine.

### BACKGROUND

Agricultural irrigation systems, such as center pivot irrigation machines, are commonly used to irrigate agricultural crops. A center pivot irrigation machine typically includes, among other things, a central pivot communicating with a pressurized water supply, a series of mobile support towers connected to the central pivot and to one another by truss-type framework sections, an elevated water distribution conduit supported by the framework sections, and a number of sprinkler heads, spray guns, drop nozzles, or other fluid-emitting devices spaced along the length of the conduit. The mobile support towers are conventionally supported on wheels that are typically driven at slow speeds to move the system in a generally circular path about the central pivot to irrigate a large tract of land.

Conventionally, the wheels of the support towers are driven by an electric motor on each tower. Such an arrangement provides satisfactory performance in many respects, although those of ordinary skill in the art will appreciate that it can be expensive to provide electric power to numerous motors on a large irrigation system. This necessary cost of procuring and transmitting electrical power to the motors is expensive to an operator of such an irrigation system, the type of which are often operational in a field for long periods of time.

### SUMMARY

The present invention provides a wind powered irrigation machine that harnesses wind energy in the movement of passing air to rotate a rotor assembly that turns a generator of electrical energy and uses the electrical energy to power a drive motor on a mobile tower of the irrigation machine. The irrigation system is economical to operate, as the electricity used to power the motors is generated on site from the energy in the movement of passing air. The wind is an abundant energy source, particularly in light of the fact that the location of many fields that must be irrigated is in an open location with considerable amounts of passing air.

According to one aspect of the present invention, an irrigation system having a liquid conduit that spans mobile towers is provided, wherein each of the mobile towers includes at least one ground-engaging wheel. A rotor assembly is provided, wherein the rotor assembly is operable to be rotated by the movement of passing air and thereby produce a rotational output. A generator of electrical energy is provided, wherein the generator is driven by the rotational output. An electrical charge source is provided in electrical communication with the generator, wherein the electrical charge source receives the electrical energy from the generator. A motor is provided in electrical communication with the electrical charge source, wherein the motor receives the electrical energy from the electrical charge source and drives the ground-engaging wheel.

Another aspect of the present invention concerns a method of moving a mobile tower of an irrigation system by rotating the wind-receiving elements of a rotor assembly with wind energy in the movement of passing air, generating electrical energy from the rotation of the rotor assembly, transmitting the electrical energy to a motor of a mobile tower, and driving the ground-engaging wheels of the mobile tower with the motor.

This summary is provided to introduce a selection of concepts in a simplified form that are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWINGS

A preferred embodiment of the present invention is described in detail below with reference to the attached drawing figures, wherein:

FIG. 1 is a perspective view on a reduced scale of a wind powered center pivot irrigation system constructed in accordance with the principles of the present invention, including a tail-type directional controller; and

FIG. 2 is a fragmentary, perspective view of the central pivot of the wind powered irrigation system shown in FIG. 1, particularly illustrating in detail the rotor assembly pivotally mounted on a support member, a pair of wind-engaging elements, and the tail-type directional controller.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

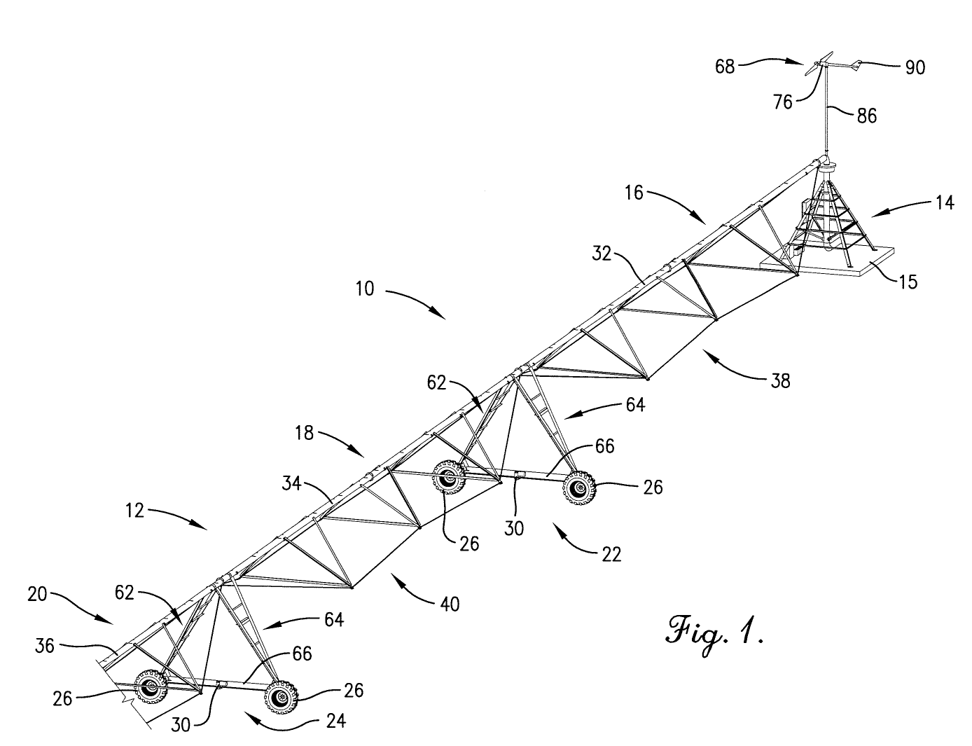

With initial reference to FIG. 1, an irrigation system 10 selected for purposes of illustration is a center pivot irrigation system that broadly includes a main section 12 and a central pivot 14. The central pivot 14 is mounted on a foundation 15 and has access to a well, water tank, or other source of pressurized fluids (not shown). The source of fluids may be coupled with a tank or other source of agricultural products to inject fertilizers, pesticides, and/or other chemicals into the fluids for application during irrigation, as will be readily appreciated by one of ordinary skill in the art.

The main section 12 includes a number of interconnected spans such as 16, 18, and 20 supported by mobile towers 22 and 24 (also referred to as intermediate towers), and an end tower (not shown). Those of ordinary skill in the art will appreciate that the irrigation system 10 may include any number of spans and mobile towers. It will also be recognized that the principles of the present invention are not limited to use with a center pivot system, but may also be employed with other types of irrigation systems, including for example, lateral move systems and other types that do not employ a fixed, central pivot.

As is well known in the art, each of the mobile towers 22 and 24 include wheels 26. At least one of the wheels 26 on each of the mobile towers 22 and 24 is preferably driven by a suitable drive motor 30, as is known in the art and discussed in more detail below. As is also well known, each drive motor 30 for the mobile towers 22 and 24 is typically controlled by a suitable safety system (not shown) such that the motor 30 can be slowed to maintain alignment of the conduit sections carried by the towers, or completely shut down, in the event of the detection of an adverse circumstance.

As is also known in the art, each of the spans 16, 18, and 20 includes a liquid carrying conduit 32, 34, and 36 that is connected in fluid flow communication with all other conduits of the system to provide liquid along the length of the system to numerous sprinklers or other water emitting devices (not shown) in order to irrigate a field. The conduits 32, 34, and 36 are each slightly arched or bowed upward when empty and are supported in such condition by truss-type frameworks 38, 40, and 42 or other supports connected to the conduits 32, 34, and 36 and disposed below the same.

Further, as is conventional, one or more high pressure sprayers or end guns (not shown) may be mounted to the end tower (not shown). The end gun is typically activated at the corners of a field or other designated areas to increase the amount of land that can be irrigated, as is known by one of ordinary skill in the art. Additional elements, such as booster pumps (not shown), may be coupled with the end gun to increase its range, as will be appreciated by one of ordinary skill in the art.

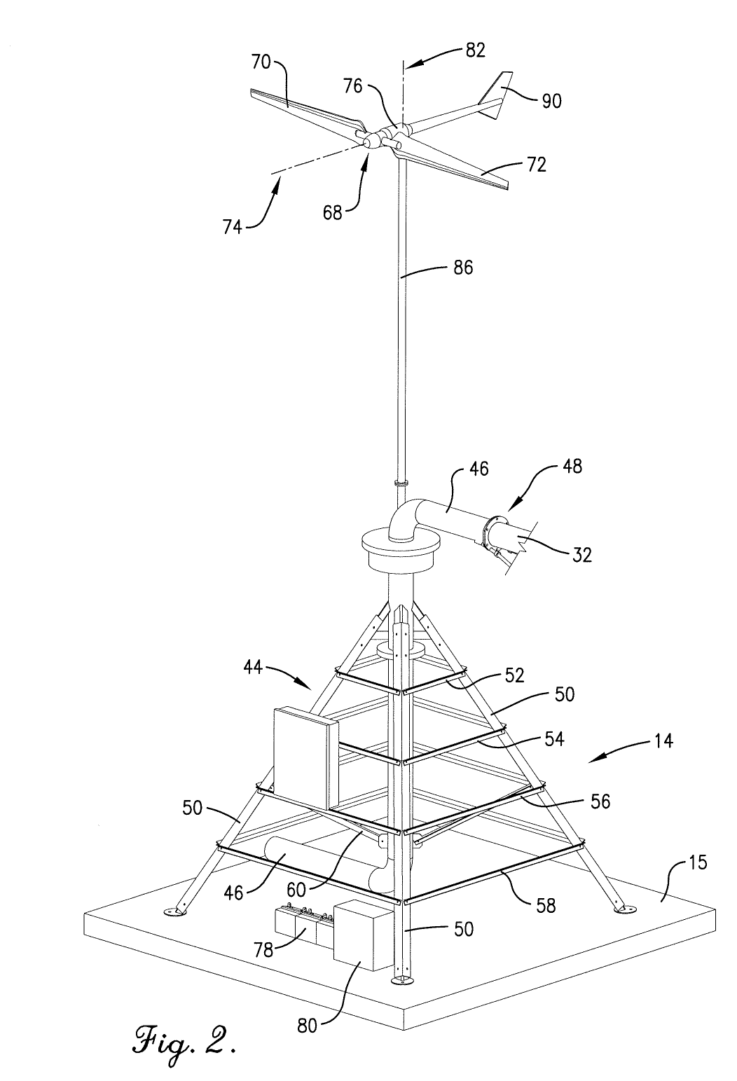

Turning now to FIG. 2, the central pivot 14 includes a stabilizing frame 44 mounted to the foundation 15 that supports a source conduit 46. The source conduit 46 connects to the first liquid carrying conduit 32 at a junction 48. In the illustrated embodiment, the frame 44 includes a plurality of support legs 50 disposed equidistantly around the source conduit 46 in a generally pyramid shape. Each adjacent pair of support legs 50 is connected by cross members 52, 54, 56, and 58, and each support leg 50 further includes an internal support member 60 that directly supports the source conduit 46. It will be readily appreciated by one of ordinary skill in the art that the supporting frame could be provided with any suitable shape and number of elements appropriate to support a source conduit and form a central pivot without departing from the teachings of the present invention.

Returning now to FIG. 1, the mobile towers 22 and 24 will be described in greater detail. The mobile towers 22 and 24 each include a pair of angle braces 62 and 64 that extend from a generally common point of connection to the liquid carrying conduits 32, 34, and 36 in a generally downward and outward direction to the wheels 26, respectively. A drive frame element 66 connects the lower ends of the angle braces 62 and 64, and extends generally horizontally therebetween.

As discussed briefly above, the motor 30 drives at least one wheel 26. In the illustrated embodiment, the motor 30 is mounted on the drive frame element 66, although a drive motor mounted to any other part of an irrigation machine is clearly within the ambit of the present invention. The output of the motor 30 is drivingly interconnected to a drive shaft (not shown in detail) to transmit the rotation from the motor 30 to the wheel 26. As will be readily appreciated by one of ordinary skill in the art, the other wheel 26 could also be similarly driven, either by the same motor 30 or an additional such motor without departing from the teachings of the present invention.

Now, with continued reference to FIG. 2, a rotor assembly 68 is depicted mounted above the central pivot 14 for rotation from the movement of passing air. Such placement of the rotor assembly 68 is by way of example only, and it will be readily appreciated by one of ordinary skill in the art that an alternative rotor assembly, or multiple rotor assemblies, could be disposed at other locations on an irrigation system, such as on the mobile towers or above the conduits, without departing from the teachings of the present invention. In the illustrated embodiment, the rotor assembly 68 includes a pair of angled blades 70 and 72 that directly receive the wind and rotate about a horizontal axis 74. It is noted that while two angled blades 70 and 72 are depicted, any suitable number of wind-receiving elements may be used without departing from the teachings of the present invention. It is further noted that while the illustrated axis 74 is shown to be generally horizontal, other orientations for an axis of rotation are also within the ambit of the present invention.

The rotor assembly 68 is connected to a generator 76 such that the rotational output of the rotor assembly 68 turns the generator 76 to create electrical energy in a manner readily known to one of ordinary skill in the art. The generator 76 is in electrical communication with an electrical charge source 78 by wiring (not shown) or other suitable connection as known in the art. In the illustrated embodiment, the electrical charge source 78 is mounted on the foundation 15, although an electrical charge source mounted to any other part of an irrigation machine is clearly within the ambit of the present invention. In the illustrated embodiment, the electrical charge source 78 comprises one or more rechargeable batteries, although other conventional power supply elements, such as capacitors, direct wire conduits, or receptacles to receive the same, are also within the ambit of the present invention.

The electrical charge source 78 is associated with the motors 30 to provide electrical power thereto via wiring (not shown) or other suitable connection as known in the art. It is noted that the electrical charge source 78, powered by electrical energy from the generator 76, could also provide power to other components of the irrigation system 10, such as a booster pump or an end gun (not shown), without departing from the teachings of the present invention.

In the illustrated embodiment, the electrical charge source 78 is electrically connected to a current inverter 80 prior to the connection to the motors 30. Also in the illustrated embodiment, the inverter 80 is mounted on the foundation 15, although an inverter mounted to any other part of an irrigation machine is clearly within the ambit of the present invention. The current inverter 80 changes the flow of electric current from direct current supplied by the electrical charge source 78 to alternating current to power the motors 30. While in a preferred embodiment, the motors 30 are driven by alternating current, and therefore the inverter 80 is incorporated to supply the appropriate type of electrical current, it is clearly within the ambit of the present invention to provide alternative motors driven by direct current that could be associated directly with the electrical charge source 78 without the need for the inverter 80.

As discussed above, the powering of the motors 30 turns the wheels 26 through the drive shaft (not shown) to move the mobile towers 22 and 24 to allow the main section 12 of the illustrated irrigation system 10 to move in a circle about the central pivot 14 to irrigate a field. The movement of the motors 30 on each mobile tower 22 and 24 is controlled by methods readily known by one of ordinary skill in the art. It is noted that the generator 76 and the motors 30 are sized for the requirements of the irrigation system 10, as will be readily appreciated by one of ordinary skill in the art. Further, while the illustrated embodiment depicts the generator 76 mounted to the central pivot 14, it could be mounted elsewhere without departing from the principles of the present invention.

With further reference to FIG. 2, it is noted that the relative angular position of the rotor assembly 68 is configured for pivoting movement about an axis 82. A vertical support member 86 extends upwardly from the central pivot 14 and coaxially along axis 82. The rotor assembly 68 is pivotally coupled to the top end of the support member 86. It is noted that while in the illustrated embodiment, the pivoting axis 82 of the rotor assembly 68 and the rotating axis 74 of the blades 70 and 72 are generally orthogonal to each other, such disposition is by way of example only, and such axes could be positioned at other orientations without departing from the teachings of the present invention.

Preferably, although not necessarily, the relative angular position of the rotor assembly 68 is controlled by a directional controlling tail 90. The tail 90 is operable to orient the relative angular position of the rotor assembly 68 so that the blades 70 and 72 are aligned with the incoming direction of the prevailing wind. As the tail 90 catches the wind, the rotor assembly 68 is pivoted about the axis 82. It is noted that in the illustrated embodiment, the tail 90 is aligned with the rotating axis 74 and takes the form of a vertically extending plane to catch the wind, although such orientation and shape are by way of example only, as will be understood by one of ordinary skill in the art. An alternative directional controller could take additional, even non-mechanical forms, without departing from the teachings of the present invention. For example, it is within the ambit of the present invention to provide an alternate embodiment (not shown) of a directional controller that controls the relative angular position of the rotor assembly 68 by using an encoder and a programmable controller. Such a system could take inputs of wind speed and direction and output a position for the rotor assembly 68 that may be set and maintained by a stepper motor or other conventional device for setting and maintaining rotational position.

The method of moving the mobile towers 22 and 24 of the irrigation system 10 should be apparent from the foregoing description and, therefore, will be described here only briefly. In particular, wind energy from the movement of passing air contacts the angled blades 70 and 72, causing the rotor assembly 68 to rotate about axis 74. The rotational output of the rotor assembly 68 turns the generator 76, which generates electrical energy. The electrical energy is transmitted to an electrical charge source 78, such as a rechargeable battery or the like, on the central pivot foundation 15. The electrical energy is then transmitted to the motors 30 that drive the wheels 26 of the mobile towers 22 and 24, as will be readily appreciated by one of ordinary skill in the art upon review of this disclosure.

It is noted, as above, that in the illustrated embodiment, the electrical energy is transmitted to a current inverter 80 between the electrical charge source 78 and the motors 30. The inverter 80 changes the form of the electrical current from direct current to alternating current in order to power alternating current motors. Alternatively, direct current motors could be used instead and no passing of the electrical current through the inverter 80 would be required, as will also be readily appreciated by one of ordinary skill in the art.

As depicted in the illustrated embodiment, wind energy from the movement of passing air also contacts the tail 90 to align the rotor assembly 68 with the incoming direction of the prevailing wind, as the rotor assembly 68 pivots about the axis 82 at the top section of the support member 86. While this pivoting movement is dictated by the tail 90 as illustrated, this movement could alternatively be carried out by electronic controls or sensors without departing from the teachings of the present invention.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and access the reasonably fair scope of the present invention as pertains to any apparatus not materially departing from but outside the literal scope of the invention set forth in the following claims.

What is claimed is:

1. In an irrigation system having a liquid conduit that spans mobile towers, each of the mobile towers including at least one ground-engaging wheel, the improvement comprising:
a rotor assembly operable to be rotated by the movement of passing air and thereby produce a rotational output;
a generator of electrical energy,
said generator being driven by the rotational output;
an electrical charge source in electrical communication with the generator,
said electrical charge source receiving the electrical energy from the generator; and
a motor in electrical communication with the electrical charge source,
said motor receiving the electrical energy from the electrical charge source,
said motor driving the ground-engaging wheel.

2. In the irrigation system as claimed in claim 1,
said tower including a drive frame member at the lower end thereof,
said drive frame member being disposed adjacent the ground-engaging wheel,
said motor being attached to the drive frame member for rigid support thereon.

3. In the irrigation system as claimed in claim 1,
said electrical change source at least temporarily storing electrical energy from the generator.

4. In the irrigation system as claimed in claim 3,
said electrical charge source comprising a battery,
said battery being charged by receiving the electrical energy from the generator.

5. In the irrigation system as claimed in claim 1,
said rotor assembly including a plurality of wind-receiving elements,
each of said plurality of wind-receiving elements being rotatable about a first axis.

6. In the irrigation system as claimed in claim 5,
said rotor assembly being pivotally disposed on a support for pivoting movement about a second axis.

7. In the irrigation system as claimed in claim 6,
said first axis and said second axis being generally orthogonal relative to one another.

8. In the irrigation system as claimed in claim 7,
said first axis being aligned at a generally horizontal disposition and said second axis being aligned at a generally vertical disposition.

9. In the irrigation system as claimed in claim 8; and
a directional controller,
said directional controller operable to orient the rotor assembly such that the plurality of wind-receiving elements are aligned with the incoming direction of prevailing wind.

10. In the irrigation system as claimed in claim 9,
said directional controller comprising a tail element,
said tail element being aligned with the first axis and disposed in a generally vertical plane.

11. In the irrigation system as claimed in claim 10,
said wind-receiving elements comprising a pair of angled blades,
each one of said pair of angled blades extending radially outwardly from a common location disposed along the first axis.

12. In the irrigation system as claimed in claim 1,
said irrigation system comprising a center pivot system, wherein the liquid conduit extends radially outwardly from a central pivot.

13. In the irrigation system as claimed in claim 12,
said rotor assembly being mounted to the central pivot.

14. In the irrigation system as claimed in claim 13; and
a rotor assembly support member mounted to the central pivot and extending generally vertically upwardly therefrom,
said rotor assembly being disposed on the rotor assembly support member.

15. In the irrigation system as claimed in claim 14,
said rotor assembly including a plurality of wind-receiving elements,
each one of said plurality of wind-receiving elements being rotatable about a first axis,
said rotor assembly being supported for pivoting movement about a second axis,
said first axis and said second axis being generally orthogonal relative to one another.

16. In the irrigation system as claimed in claim 15; and
an inverter in electrical communication with the electrical charge source and also in electrical communication with the motor,
said electrical energy being transmitted from the electrical charge source to the inverter as direct current,
said inverter changing the flow of the electric current from direct current to alternating current and transmitting the alternating current to the motor,
said motor being powered by the alternating current.

17. In the irrigation system as claimed in claim 16,
said inverter being disposed at the central pivot and said electrical charge source being disposed at the central pivot.

18. In the irrigation system as claimed in claim 1; and
an inverter in electrical communication with the electrical charge source and also in electrical communication with the motor,
said electrical energy being transmitted from the electrical charge source to the inverter as direct current,
said inverter changing the flow of the electric current from direct current to alternating current and transmitting the alternating current to the motor,
said motor being powered by the alternating current.

19. A method of moving a mobile tower of an irrigation system, said method comprising the steps of:
rotating the wind-receiving elements of a rotor assembly with wind energy in the movement of passing air;
generating electrical energy from the rotation of the rotor assembly;
transmitting the electrical energy to a motor of a mobile tower; and
driving the ground-engaging wheels of the mobile tower with the motor.

20. The tower moving method as claimed in claim 19,
said rotating step including the step of aligning the rotor assembly with the incoming direction of prevailing wind.

21. The tower moving method as claimed in claim 20,
said aligning step including the step of pivoting the rotor assembly about a generally vertical axis to face the prevailing wind.

22. The tower moving method as claimed in claim 21,
said pivoting step including the step of controlling the facing direction of the rotor assembly with a directional control system.

23. The tower moving method as claimed in claim 22,
said controlling step including the step of catching the prevailing wind with a generally vertically disposed tail to orient the facing direction of the rotor assembly with the direction of the prevailing wind.

24. The tower moving method as claimed in claim 23,
said transmitting step including the step of inverting the flow of electrical energy from direct current to alternating current and powering the motor with alternating current.

25. The tower moving method as claimed in claim 19,
said transmitting step including the step of inverting the flow of electrical energy from direct current to alternating current and powering the motor with alternating current.
